(19) United States
(12) Patent Application Publication
(10) Pub. No.: US 2002/0120368 A1
(43) Pub. Date: Aug. 29, 2002

(54) Distributed energy network control system and method

(76) Inventors: Edward C. Edelman, Agoura Hills, CA (US); Mark G. Gilbreth, Simi Valley, CA (US); Wiley Gilreath, Simi Valley, CA (US)

Correspondence Address: IRELL & MANELLA LLP, Suite 900, 1800 Avenue of the Stars, Los Angeles, CA, 90067, US

(21) Appl. No.: 10/002,327

(22) Filed: Nov. 1, 2001

Related U.S. Application Data
(60) Provisional application No. 60/244,871, filed on Nov. 1, 2000.

(51) Int. Cl. G05D 3/12

(52) U.S. Cl. 700/286

(57) ABSTRACT

An energy management network according to the present disclosure may include remote distributed energy generation elements, and/or network connected multi element generation groups, and/or network connected energy generation elements. In a currently preferred embodiment, energy generating elements are turbogenerators as described above. An energy management network according to the present disclosure may include one or more Energy Network (EnerNet) Controllers for the purpose of controlling and/or monitoring a network of energy generation units, which work separately or in coordinated activities. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or meaning of the claims.

### RELATED APPLICATIONS

This application claims the priority of U.S. provisional patent application Serial No. 60/244,871 filed Nov. 01, 2000.

### BACKGROUND OF THE INVENTION

1. Field of the Invention

This invention relates to power system controls, and more specifically to network control systems and methods for distributed energy generation systems.

2. Description of the Prior Art

What is needed is a control system and network for controlling and managing distributed energy generation systems.

### SUMMARY OF THE INVENTION

In a first aspect, the present disclosure provides an energy generation network having a plurality of energy generating elements, each energy generating element capable of producing energy and having a plurality of operating parameters and a controller for controlling and communicating with each of the plurality of energy generating elements and a communication network interconnecting the plurality of energy generating elements and the controller.

In another aspect, the present disclosure includes a method of delivering electrical energy using the steps of: providing two or more energy generation units to provide electrical energy and monitoring one or more parameters of the two or more energy generation units in a control unit, and communicating with one or more external devices to determine energy demands and transmitting commands from the control unit to one or more of the two or more energy generation units to operate the two or more energy generation units according to the monitored parameters and energy demands.

These and other features and advantages of this invention will become further apparent from the detailed description and accompanying figures that follow. In the figures and description, numerals indicate the various features of the invention, like numerals referring to like features throughout both the drawings and the description.

### BRIEF DESCRIPTION OF THE DRAWINGS

FIG. 1A is perspective view, partially in section, of an integrated turbogenerator system.

FIG. 1B is a magnified perspective view, partially in section, of the motor/generator portion of the integrated turbogenerator of FIG. 1A.

FIG. 1C is an end view, from the motor/generator end, of the integrated turbogenerator of FIG. 1A.

FIG. 1D is a magnified perspective view, partially in section, of the combustor-turbine exhaust portion of the integrated turbogenerator of FIG. 1A.

FIG. 1E is a magnified perspective view, partially in section, of the compressor-turbine portion of the integrated turbogenerator of FIG. 1A.

FIG. 2 is a block diagram schematic of a turbogenerator system including a power controller having decoupled rotor speed, operating temperature, and DC bus voltage control loops.

FIG. 3 is a system block diagram of a distributed energy generation system controlled according to the present disclosure.

FIG. 4 is a block diagram of the communication channels of a distributed energy generation controller according to the present disclosure.

### DETAILED DESCRIPTION OF THE PREFERRED EMBODIMENT(S)

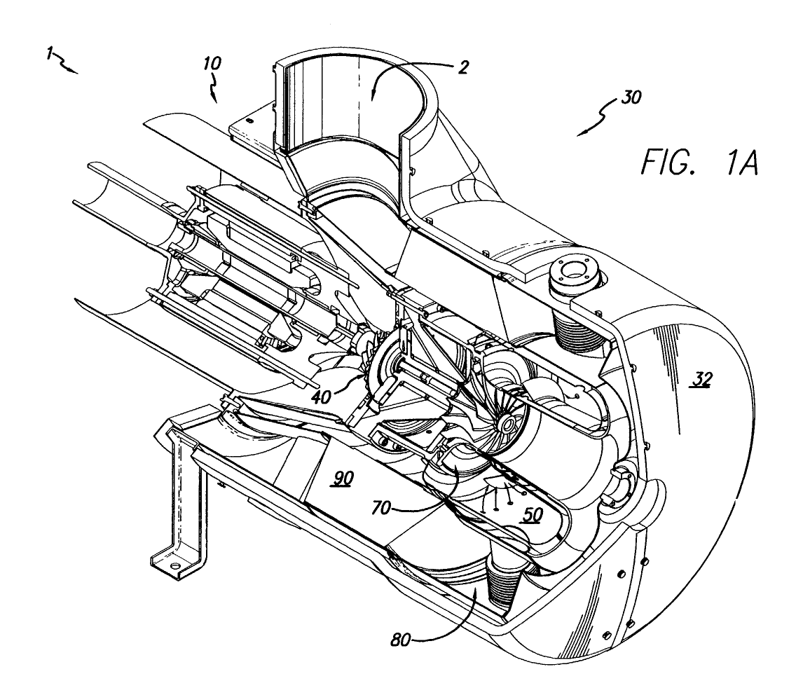

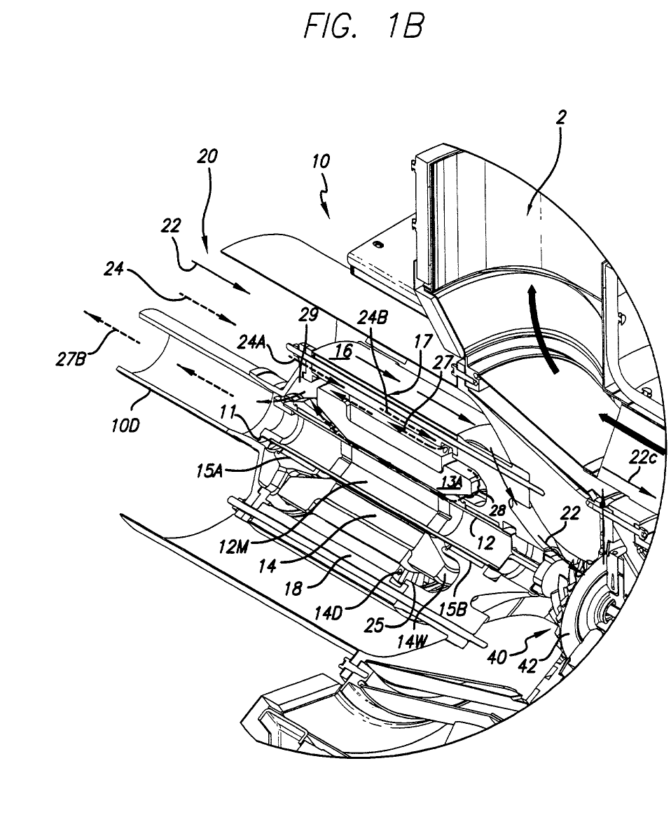

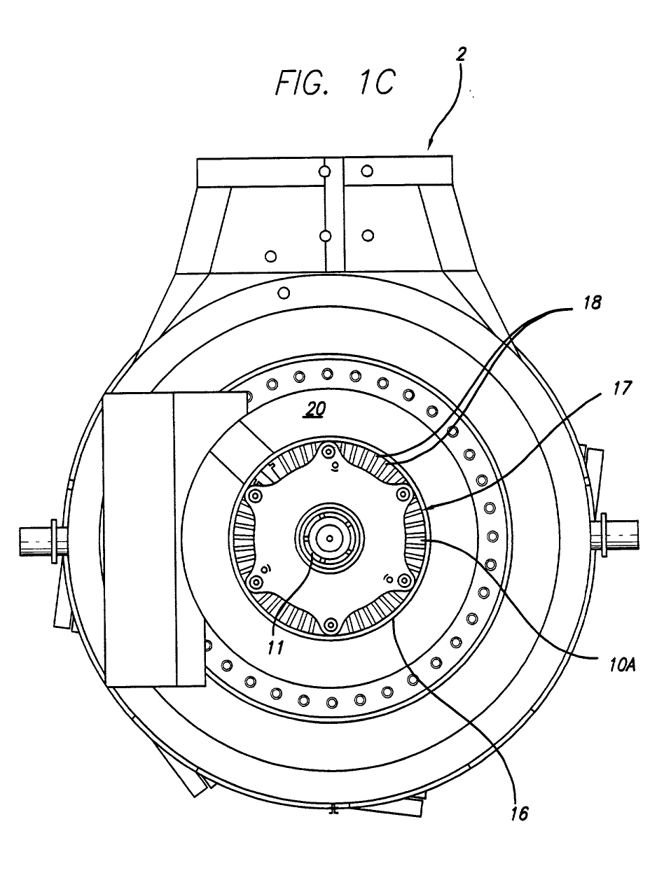

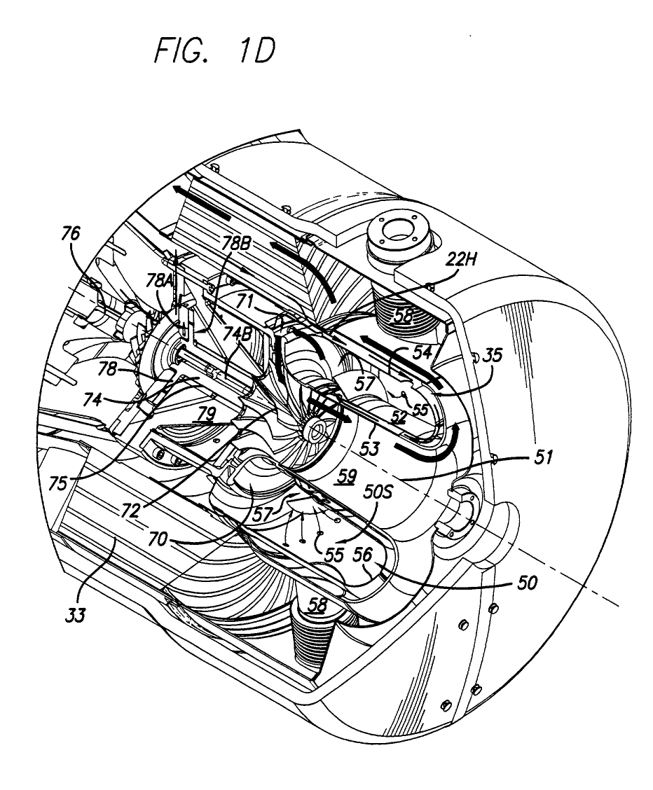

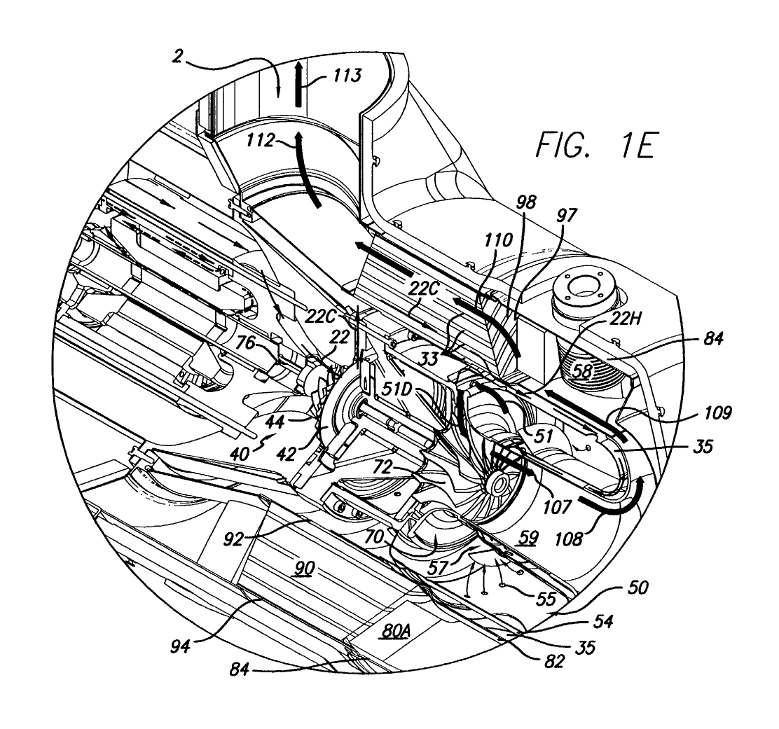

With reference to FIG. 1A, an integrated turbogenerator 1 according to the present invention generally includes motor/generator section 10 and compressor-combustor section 30. Compressor-combustor section 30 includes exterior can 32, compressor 40, combustor 50 and turbine 70. A recuperator 90 may be optionally included.

Referring now to FIG. 1B and FIG. 1C, in a currently preferred embodiment of the present invention, motor/generator section 10 may be a permanent magnet motor generator having a permanent magnet rotor or sleeve 12. Any other suitable type of motor generator may also be used. Permanent magnet rotor or sleeve 12 may contain a permanent magnet 12M. Permanent magnet rotor or sleeve 12 and the permanent magnet disposed therein are rotatably supported within permanent magnet motor/generator stator 14. Preferably, one or more compliant foil, fluid film, radial, or journal bearings 15A and 15B rotatably support permanent magnet rotor or sleeve 12 and the permanent magnet disposed therein. All bearings, thrust, radial or journal bearings, in turbogenerator 1 may be fluid film bearings or compliant foil bearings. Motor/generator housing 16 encloses stator heat exchanger 17 having a plurality of radially extending stator cooling fins 18. Stator cooling fins 18 connect to or form part of stator 14 and extend into annular space 10A between motor/generator housing 16 and stator 14. Wire windings 14W exist on permanent magnet motor/generator stator 14.

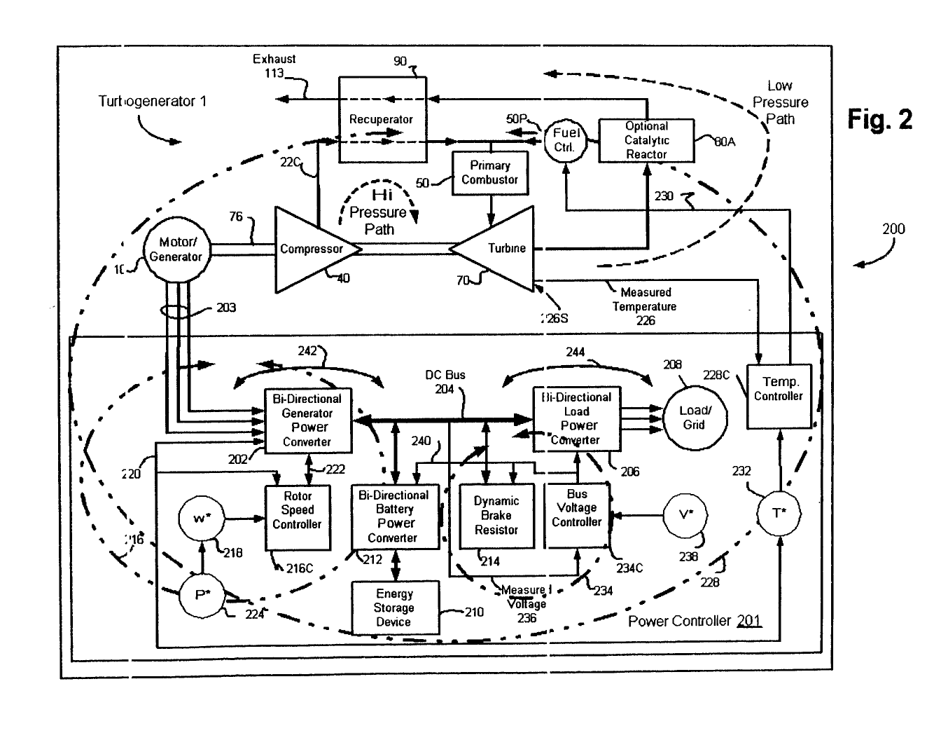

Referring now to FIG. 1D, combustor 50 may include cylindrical inner wall 52 and cylindrical outer wall 54. Cylindrical outer wall 54 may also include air inlets 55. Cylindrical walls 52 and 54 define an annular interior space 50S in combustor 50 defining an axis 51. Combustor 50 includes a generally annular wall 56 further defining one axial end of the annular interior space of combustor 50. Associated with combustor 50 may be one or more fuel injector inlets 58 to accommodate fuel injectors which receive fuel from fuel control element SOP as shown in FIG. 2, and inject fuel or a fuel air mixture to interior of 50S combustor 50. Inner cylindrical surface 53 is interior to cylindrical inner wall 52 and forms exhaust duct 59 for turbine 70.

Turbine 70 may include turbine wheel 72. An end of combustor 50 opposite annular wall 56 further defines an aperture 71 in turbine 70 exposed to turbine wheel 72. Bearing rotor 74 may include a radially extending thrust bearing portion, bearing rotor thrust disk 78, constrained by bilateral thrust bearings 78A and 78B. Bearing rotor 74 may be rotatably supported by one or more journal bearings 75 within center bearing housing 79. Bearing rotor thrust disk 78 at the compressor end of bearing rotor 76 is rotatably supported preferably by a bilateral thrust bearing 78A and 78B. Journal or radial bearing 75 and thrust bearings 78A and 78B may be fluid film or foil bearings.

Turbine wheel 72, Bearing rotor 74 and Compressor impeller 42 may be mechanically constrained by tie bolt 74B, or other suitable technique, to rotate when turbine wheel 72 rotates. Mechanical link 76 mechanically constrains compressor impeller 42 to permanent magnet rotor or sleeve 12 and the permanent magnet disposed therein causing permanent magnet rotor or sleeve 12 and the permanent magnet disposed therein to rotate when compressor impeller 42 rotates.

Referring now to FIG. 1E, compressor 40 may include compressor impeller 42 and compressor impeller housing 44. Recuperator 90 may have an annular shape defined by cylindrical recuperator inner wall 92 and cylindrical recuperator outer wall 94. Recuperator 90 contains internal passages for gas flow, one set of passages, passages 33 connecting from compressor 40 to combustor 50, and one set of passages, passages 97, connecting from turbine exhaust 80 to turbogenerator exhaust output 2.

Referring again to FIG. 1B and FIG. 1C, in operation, air flows into primary inlet 20 and divides into compressor air 22 and motor/generator cooling air 24. Motor/generator cooling air 24 flows into annular space 10A between motor/generator housing 16 and permanent magnet motor/generator stator 14 along flow path 24A. Heat is exchanged from stator cooling fins 18 to generator cooling air 24 in flow path 24A, thereby cooling stator cooling fins 18 and stator 14 and forming heated air 24B. Warm stator cooling air 24B exits stator heat exchanger 17 into stator cavity 25 where it further divides into stator return cooling air 27 and rotor cooling air 28. Rotor cooling air 28 passes around stator end 13A and travels along rotor or sleeve 12. Stator return cooling air 27 enters one or more cooling ducts 14D and is conducted through stator 14 to provide further cooling. Stator return cooling air 27 and rotor cooling air 28 rejoin in stator cavity 29 and are drawn out of the motor/generator 10 by exhaust fan 11 which is connected to rotor or sleeve 12 and rotates with rotor or sleeve 12. Exhaust air 27B is conducted away from primary air inlet 20 by duct 10D.

Referring again to FIG. 1E, compressor 40 receives compressor air 22. Compressor impeller 42 compresses compressor air 22 and forces compressed gas 22C to flow into a set of passages 33 in recuperator 90 connecting compressor 40 to combustor 50. In passages 33 in recuperator 90, heat is exchanged from walls 98 of recuperator 90 to compressed gas 22C. As shown in FIG. 1E, heated compressed gas 22H flows out of recuperator 90 to space 35 between cylindrical inner surface 82 of turbine exhaust 80 and cylindrical outer wall 54 of combustor 50. Heated compressed gas 22H may flow into combustor 54 through sidewall ports 55 or main inlet 57. Fuel (not shown) may be reacted in combustor 50, converting chemically stored energy to heat. Hot compressed gas 51 in combustor 50 flows through turbine 70 forcing turbine wheel 72 to rotate. Movement of surfaces of turbine wheel 72 away from gas molecules partially cools and decompresses gas 51D moving through turbine 70. Turbine 70 is designed so that exhaust gas 107 flowing from combustor 50 through turbine 70 enters cylindrical passage 59. Partially cooled and decompressed gas in cylindrical passage 59 flows axially in a direction away from permanent magnet motor/generator section 10, and then radially outward, and then axially in a direction toward permanent magnet motor/generator section 10 to passages 98 of recuperator 90, as indicated by gas flow arrows 108 and 109 respectively.

In an alternate embodiment of the present invention, low pressure catalytic reactor 80A may be included between fuel injector inlets 58 and recuperator 90. Low pressure catalytic reactor 80A may include internal surfaces (not shown) having catalytic material (e.g., Pd or Pt, not shown) disposed on them. Low pressure catalytic reactor 80A may have a generally annular shape defined by cylindrical inner surface 82 and cylindrical low pressure outer surface 84. Unreacted and incompletely reacted hydrocarbons in gas in low pressure catalytic reactor 80A react to convert chemically stored energy into additional heat, and to lower concentrations of partial reaction products, such as harmful emissions including nitrous oxides (NOx).

Gas 110 flows through passages 97 in recuperator 90 connecting from turbine exhaust 80 or catalytic reactor 80A to turbogenerator exhaust output 2, as indicated by gas flow arrow 112, and then exhausts from turbogenerator 1, as indicated by gas flow arrow 113. Gas flowing through passages 97 in recuperator 90 connecting from turbine exhaust 80 to outside of turbogenerator 1 exchanges heat to walls 98 of recuperator 90. Walls 98 of recuperator 90 heated by gas flowing from turbine exhaust 80 exchange heat to gas 22C flowing in recuperator 90 from compressor 40 to combustor 50.

Turbogenerator 1 may also include various electrical sensor and control lines for providing feedback to power controller 201 and for receiving and implementing control signals as shown in FIG. 2.

Alternative Mechanical Structural Embodiments of the Integrated Turbogenerator

The integrated turbogenerator disclosed above is exemplary. Several alternative structural embodiments are known.

In one alternative embodiment, air 22 may be replaced by a gaseous fuel mixture. In this embodiment, fuel injectors may not be necessary. This embodiment may include an air and fuel mixer upstream of compressor 40.

In another alternative embodiment, fuel may be conducted directly to compressor 40, for example by a fuel conduit connecting to compressor impeller housing 44. Fuel and air may be mixed by action of the compressor impeller 42. In this embodiment, fuel injectors may not be necessary.

In another alternative embodiment, combustor 50 may be a catalytic combustor.

In another alternative embodiment, geometric relationships and structures of components may differ from those shown in FIG. 1A. Permanent magnet motor/generator section 10 and compressor/combustor section 30 may have low pressure catalytic reactor 80A outside of annular recuperator 90, and may have recuperator 90 outside of low pressure catalytic reactor 80A. Low pressure catalytic reactor 80A may be disposed at least partially in cylindrical passage 59, or in a passage of any shape confined by an inner wall of combustor 50. Combustor 50 and low pressure catalytic reactor 80A may be substantially or completely enclosed with an interior space formed by a generally annularly shaped recuperator 90, or a recuperator 90 shaped to substantially enclose both combustor 50 and low pressure catalytic reactor 80A on all but one face.

Alternative Use of the Invention Other than in Integrated Turbogenerators

An integrated turbogenerator is a turbogenerator in which the turbine, compressor, and generator are all constrained to rotate based upon rotation of the shaft to which the turbine is connected. The invention disclosed herein is preferably but not necessarily used in connection with a turbogenerator, and preferably but not necessarily used in connection with an integrated turbogenerator.

Turbogenerator System Including Controls

Referring now to FIG. 2, a preferred embodiment is shown in which a turbogenerator system 200 includes power controller 201 which has three substantially decoupled control loops for controlling (1) rotary speed, (2) temperature, and (3) DC bus voltage. A more detailed description of an appropriate power controller is disclosed in U.S. patent application Ser. No. 09/207,817, filed Dec. 8, 1998 in the names of Gilbreth, Wacknov and Wall, and assigned to the assignee of the present application which is incorporated herein in its entirety by this reference.

Referring still to FIG. 2, turbogenerator system 200 includes integrated turbogenerator 1 and power controller 201. Power controller 201 includes three decoupled or independent control loops.

A first control loop, temperature control loop 228, regulates a temperature related to the desired operating temperature of primary combustor 50 to a set point, by varying fuel flow from fuel control element 50P to primary combustor 50. Temperature controller 228C receives a temperature set point, T*, from temperature set point source 232, and receives a measured temperature from temperature sensor 226S connected to measured temperature line 226. Temperature controller 228C generates and transmits over fuel control signal line 230 to fuel pump 50P a fuel control signal for controlling the amount of fuel supplied by fuel pump 50P to primary combustor 50 to an amount intended to result in a desired operating temperature in primary combustor 50. Temperature sensor 226S may directly measure the temperature in primary combustor 50 or may measure a temperature of an element or area from which the temperature in the primary combustor 50 may be inferred.

A second control loop, speed control loop 216, controls speed of the shaft common to the turbine 70, compressor 40, and motor/generator 10, hereafter referred to as the common shaft, by varying torque applied by the motor generator to the common shaft. Torque applied by the motor generator to the common shaft depends upon power or current drawn from or pumped into windings of motor/generator 10. Bi-directional generator power converter 202 is controlled by rotor speed controller 216C to transmit power or current in or out of motor/generator 10, as indicated by bi-directional arrow 242. A sensor in turbogenerator 1 senses the rotary speed on the common shaft and transmits that rotary speed signal over measured speed line 220. Rotor speed controller 216 receives the rotary speed signal from measured speed line 220 and a rotary speed set point signal from a rotary speed set point source 218. Rotary speed controller 216C generates and transmits to generator power converter 202 a power conversion control signal on line 222 controlling generator power converter 202's transfer of power or current between AC lines 203 (i.e., from motor/generator 10) and DC bus 204. Rotary speed set point source 218 may convert to the rotary speed set point a power set point P* received from power set point source 224.

A third control loop, voltage control loop 234, controls bus voltage on DC bus 204 to a set point by transferring power or voltage between DC bus 204 and any of (1) Load/Grid 208 and/or (2) energy storage device 210, and/or (3) by transferring power or voltage from DC bus 204 to dynamic brake resistor 214. A sensor measures voltage DC bus 204 and transmits a measured voltage signal over measured voltage line 236. Bus voltage controller 234C receives the measured voltage signal from voltage line 236 and a voltage set point signal V* from voltage set point source 238. Bus voltage controller 234C generates and transmits signals to bi-directional load power converter 206 and bi-directional battery power converter 212 controlling their transmission of power or voltage between DC bus 204, load/grid 208, and energy storage device 210, respectively. In addition, bus voltage controller 234 transmits a control signal to control connection of dynamic brake resistor 214 to DC bus 204.

Power controller 201 regulates temperature to a set point by varying fuel flow, adds or removes power or current to motor/generator 10 under control of generator power converter 202 to control rotor speed to a set point as indicated by bi-directional arrow 242, and controls bus voltage to a set point by (1) applying or removing power from DC bus 204 under the control of load power converter 206 as indicated by bi-directional arrow 244, (2) applying or removing power from energy storage device 210 under the control of battery power converter 212, and (3) by removing power from DC bus 204 by modulating the connection of dynamic brake resistor 214 to DC bus 204.

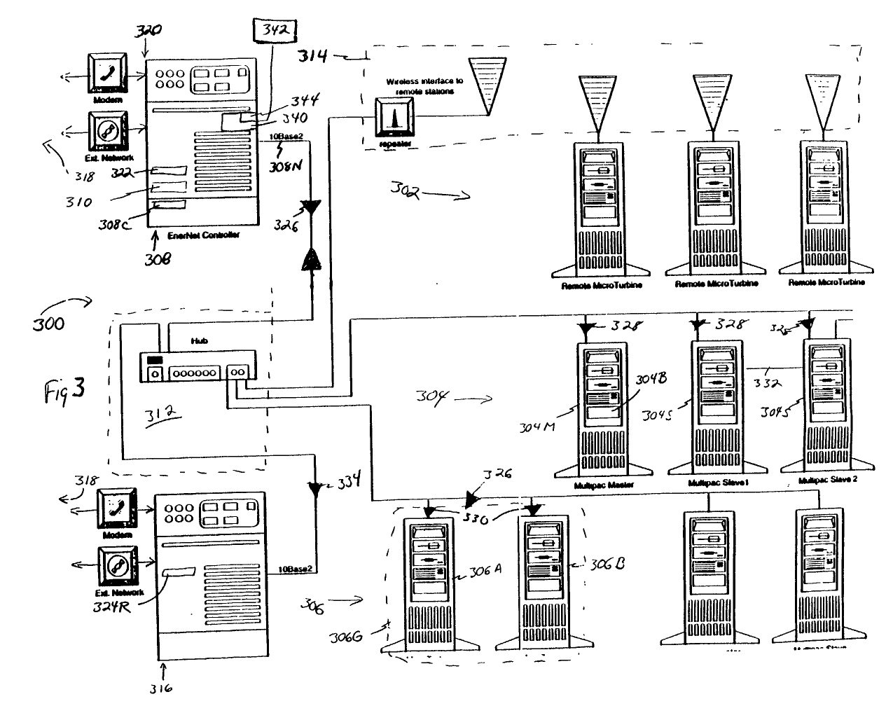

Referring now to FIG. 3, Network 300 may include remote distributed energy generation elements 302, and/or network connected multi element generation group 304, and/or network connected energy generation elements 306. In a currently preferred embodiment, energy generating elements 302, 304, and 306 are turbogenerators as described above.

Network may include one or more Energy Network (EnerNet) Controllers 308 and 312 for the purpose of controlling and/or monitoring a network of energy generation units, which work separately or in coordinated activities.

One or more controllers 308 will maintain records for each generation unit such as energy generation elements 302, 304M, 304S and/or 306. Information 310 may include each unit's maintenance history, performance history, configuration, current status, and operating parameters such as load capacity, various temperatures, control loop set points, . Each energy generation element 302 and/of 306 could consist of a Capstone MicroTurbine™ or a compatible energy generation unit (i.e. fuel cell, UPS, battery bank, etc.). Where energy generation units are configured as a network connected multi element generation group 304, one or more controllers may maintain group records such as total load requirements and status as well as individual element records.

Controller 308 and all the generation units such as energy generation elements 302, and/or 304 and/or 306 may be connected in a network configuration using one or more communications media and topologies such as network 312. Such networking may consist of, but is not necessarily limited to, Ethernet and LonWorks® in optional conjunction with wireless repeater technologies such as wireless link 314.

An EnerNet controller such as controller 308 and/or controller 316 may act as an interface between energy generation elements 302, and/or 304 and/or 306 and or the outside world 318. As a front-end gatekeeper to an energy generation network 300, controller 308 may provide one or more communication interfaces 320 through an Ethernet interface, an RS-232 interface, a 10/100BT TCP/IP interface, a modem interface, an RS-485 interface, a LonWorks interface, and a digital/analog connection board or any combination of the above or any other suitable interface. Through interface 320 such as Ethernet or RS-232, one or more users may access information 310 and control the energy network 300. Access and control may be limited based on a series of password protection levels or other access controls 322. In addition to its own configuration a controller such as controller 308 or controller 312 will be able to maintain and report a record 324R of the configuration 324 of each energy generation element 302, 304, or 306. Up to 100 energy generation elements may be controlled through network connection 308N.

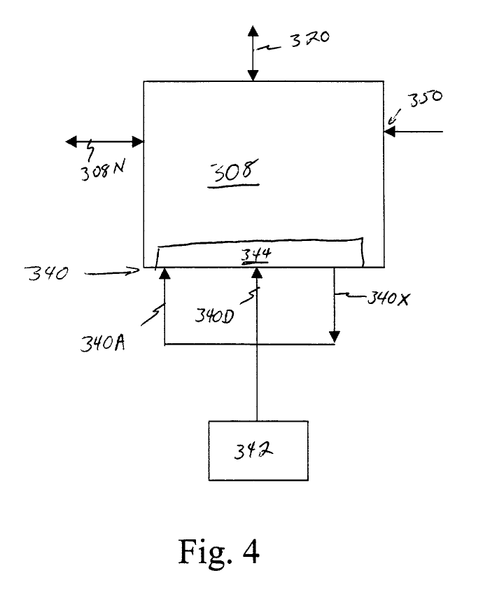

Referring now to FIG. 4, when configured to do so, controller 308 may communicate through interface 340 to external devices 342, such as other energy management computers, interfaces to electric meters, air conditioning thermostats, and user switches. Interface 340 permits access to external devices to allow controller 308 to know about energy requirements. Interface 340, according to the present disclosure, may also include one or more digital/analog connection boards 344. In a currently preferred embodiment of the present disclosure, interface 340 includes 8 analog inputs 340A, 16 discrete inputs 340D and 16 outputs 340X. Controller may be powered by 120 volt ac power or 12 volt dc power through power port 350. If DC power is used, a currently preferred embodiment of the present invention provides at least 5 minutes of uninterruptable power for Dual-Mode ride through.

Controller 308 acts as a coordinator of energy supplies. The controller maintains a real time clock and calendar 308C for scheduling. The controller will send commands 326 to each generation unit indicating whether the unit should be in shutdown, standby, or power generation states. For power generation, the unit would have voltage and/or current goals. The units are also controlled by controller 308 to enter charging states.

Sets of two or more generation units 306A and 306B may be grouped together for common control. Each group 306G might share a common schedule of activity. For example, generation elements 306A and 306B may be remotely located throughout an oil field and could all share identical operational parameters. In this case, controller 308 could distribute the same commands 330 to all the units in this group.

A grouping may include physical and electrical associations such as driving the same load, and thus may be grouped together to form a network connected multi element generation group 304. A grouping may include control interconnections 332 which allow units in a group to share information about the local power connection along with timing information. Controller 308 may designate which units are to be the ‘sync’ masters of their groups such as unit 304M.

Sub-groups consisting of Capstone MicroTurbines™ that have a sync master and drive a common load are referred to as a Capstone Multipac. The master unit 304M may or may not include in its own user connection board 304B which may allow the Multipac to operate more autonomously. Depending on the group size and configuration of a Multipac the master unit either directly controls the demand from its slaves 304S or the master will indicate to controller 308 what its total demand requirement is. Controller 308 may then direct which energy generation units within the group should participate and how much load each unit (including the master) should generate.

Controller 308 may be capable of operating with one or more redundant backup units 316. Primary unit 308 will periodically send operational information 334 over network 300 for backup unit 316 to process. A backup unit can be physically close or remotely located. A backup unit will monitor the operations over the local area network. If a backup detects that the primary unit is no longer functioning it can assume command of the network.

Using a controller according to the present disclosure with sub-groups allows for easier site maintenance and control. Controller 308 can facilitate the creation of larger and more intelligent groups 304 on the order of 100 units. Controller 308 is designed for reliability in the form of rugged design and control redundancy.

Having now described the invention in accordance with the requirements of the patent statutes, those skilled in this art will understand how to make changes and modifications in the present invention to meet their specific requirements or conditions. Such changes and modifications may be made without departing from the scope and spirit of the invention as set forth in the following claims.

What is claimed is:

1. An energy generation network comprising:
a plurality of energy generating elements, each energy generating element capable of producing energy and having a plurality of operating parameters;
a controller for controlling and communicating with each of the plurality of energy generating elements; and
a communication network interconnecting the plurality of energy generating elements and the controller.

2. The energy generation network of claim 1 wherein the plurality of energy generating elements further comprises:
a plurality of turbogenerators, each turbogenerator producing electricity and having a plurality of operating parameters.

3. The energy generation network of claim 2 wherein the plurality of turbogenerators further comprises:
a plurality of permanent magnet turbogenerators, each turbogenerator producing electricity and having a plurality of operating parameters.

4. The energy generation network of claim 1 wherein the plurality of energy generating elements further comprises:
a plurality of turbogenerators, each turbogenerator including a local power controller for independent operation and producing electricity and further including a plurality of operating parameters.

5. The energy generation network of claim 1 further comprising:
one or more communication connections to the controller permitting remote access and control of the controller and the energy generating elements.

6. The energy generation network of claim 5 wherein the one or more communication connections further comprises:
an ethernet interface.

7. The energy generation network of claim 5 wherein the one or more communication connections further comprises:
an RS-232 interface.

8. The energy generation network of claim 1 further comprising:
one or more communication connections between external devices and the controller.

9. The energy generation network of claim 8 wherein the one or more communication connections further comprises:
a Lonworks® interface.

10. The energy generation network of claim 9 wherein the one or more communication connections further comprises:
a Lonworks® interface and an analog to digital connection board.

11. A method of delivering electrical energy comprising the steps of:
providing two or more energy generation units to provide electrical energy;
monitoring one or more parameters of the two or more energy generation units in a control unit;
communicating with one or more external devices to determine energy demands;
transmitting commands from the control unit to one or more of the two or more energy generation units to operate the two or more energy generation units according to the monitored parameters and energy demands.

12. The method of claim 11 wherein the one or more external devices further comprises:
One or more of energy management computers, electric meters, air conditioning thermostats, and user switches.

13. The method of claim 11 wherein the two or more energy generation units further comprises:
two or more turbogenerators, each turbogenerator including a local power controller for independent operation and producing electricity.

14. The method of claim 11 further comprising the steps of:
providing commands to the control unit from one or more users;
transmitting commands from the control unit to one or more of the two or more energy generation units to operate the two or more energy generation units according to the user commands, the monitored parameters and energy demands.

15. The method of claim 14 wherein the step of transmitting commands from the control unit further comprises:
weighting user commands to determine priority between user commands, the monitored parameters and energy demands;
transmitting commands from the control unit to one or more of the two or more energy generation units to operate the two or more energy generation units according to prioritized user commands, the monitored parameters and energy demands.
